(19) United States
(12) Patent Application Publication
(10) Pub. No.: US 2014/0047316 A1
(43) Pub. Date: Feb. 13, 2014

(54) METHOD AND SYSTEM TO CREATE A PERSONAL PRIORITY GRAPH

(71) Applicant: Vimbli, Inc., San Francisco, CA (US)

(72) Inventors: Hendrik M. Strydom, San Francisco, CA (US); Thomas D. Rikert, San Francisco, CA (US)

(73) Assignee: Vimbli, Inc., San Francisco, CA (US)

(21) Appl. No.: 13/963,703

(22) Filed: Aug. 9, 2013

Related U.S. Application Data
(60) Provisional application No. 61/682,028, filed on Aug. 10, 2012.

(51) Int. Cl. G06F 3/0481

(52) U.S. Cl. CPC G06F 3/0481
USPC 715/233

(57) ABSTRACT

A priority associated with a user and event data associated with the user are identified. An experience annotation for an event is obtained. The experience annotation includes an emotional measure of the event. A priority graph unit is created based on the event data associated with the user and the experience annotation for the event. A personal priority graph for the user is created based on the priority graph unit.

### RELATED APPLICATIONS

This application is related to and claims the benefit of U.S. Provisional Patent application Ser. No. 61/682,028 filed Aug. 10, 2012, which is hereby incorporated by reference.

### TECHNICAL FIELD

Embodiments of the present invention relate to computing systems, and more particularly, to a technique for creating a personal priority graph.

### BACKGROUND

People may find it difficult to keep track of their priorities and to continuously make prioritized decisions regarding their allocation of time. A user can create a personal priority graph to represent the user's priorities in order to assist the user to allocate his or her time. However, getting and organizing relevant information onto a personal priority graph can be an arduous task. Current solutions to create a personal priority graph for a user can require extensive manual data capture and manipulation. Moreover, current solutions can create a personal priority graph that may not be current or may not include enough detail for the user to make informed decisions and take action. For example, a busy professional juggling work, family, and personal time may not know how much time he or she actually spends on each area of life and/or how satisfied he or she is with the time spent on each area. While electronic data may often be generated related to daily events and activities of a user, the user is typically not able to use the data without investing significant time and effort to collect, organize, and manage the data to get to insights. Moreover, the electronic data may not take into account the user's personal thoughts or experiences on the daily events and activities.

### BRIEF DESCRIPTION OF THE DRAWINGS

Various embodiments of the present invention will be understood more fully from the detailed description given below and from the accompanying drawings of various embodiments of the invention.

FIG. 1 illustrates exemplary computing device, in accordance with various embodiments of the present disclosure.

FIG. 2 is a block diagram of a personal priority graph module, in accordance with an embodiment of the present disclosure.

FIG. 3A illustrates a user interface for a set of priorities, in accordance with one embodiment of the present disclosure.

FIG. 3B illustrates a user interface for providing a status for a set of priorities, in accordance with one embodiment of the present disclosure.

FIG. 4A illustrates a user interface for providing information to a user based on a priority graph unit, in accordance with one embodiment of the present disclosure.

FIG. 4B illustrates a user interface for providing information to a user based on a priority graph unit, in accordance with another embodiment of the present disclosure.

FIG. 5A illustrates a personal priority graph, in accordance with one embodiment of the present disclosure.

FIG. 5B illustrates a personal priority graph based on a priority graph unit, in accordance with an alternate embodiment of the present disclosure.

FIG. 5C illustrates a personal priority graph based on a priority graph unit, in accordance with an alternate embodiment of the present disclosure.

FIG. 5D illustrates a personal priority graph based on a priority graph unit, in accordance with an alternate embodiment of the present disclosure.

FIG. 5E illustrates a personal priority graph based on a priority graph unit, in accordance with an alternate embodiment of the present disclosure.

FIG. 6 is a flow diagram for a method of creating a personal priority graph, in accordance with an embodiment.

FIG. 7 is a block diagram of an exemplary computer system that may perform one or more of the operations described herein.

### DETAILED DESCRIPTION

Embodiments of the invention are directed to a method and system for creating a personal priority graph.

A user can have many specific priorities in his or her life and may need to make decisions regarding his or her allocation of time in order to meet the priorities. Data related to daily events and activities for a user can be generated and stored by a computing device to assist a user of the computing device in get insight into his or her allocation of time in order to assist the user to meet his or her priorities. However, the user may not be able to use the data without investing significant time and effort to collect, organize, and manage the data. Moreover, the user may be challenged to quantify and take into account his or her experience of the daily events and activities in relation to the user's priorities. In addition, tracking overall life satisfaction and energy associated with the daily events and activities can be even more challenging and time consuming.

Aspects of the present disclosure create a personal priority graph that integrates event data and experience annotations of the user to assist the user to meet his or her priorities. The personal priority graph can provide insight to the user of his or her allocation of time. To create the personal priority graph, one or more priorities associated with a user are identified and events associated with the user are identified. Experience annotations for the events are obtained, that include subjective information about the event, such as satisfaction, energy levels, engagement levels, assessment of effort, etc. A priority graph unit is generated based on the events and the experience annotations for the events. Using the priority graph unit, a personal priority graph is created and can be presented to the user. The personal priority graph is an integration of the events and the experience annotations for the events, and provides the user with information of the events in terms of the user's identified priorities. The personal priority graph can include actionable information to assist the user to satisfy the one or more priorities, and can further provide suggestions and insights that go beyond the identified priorities.

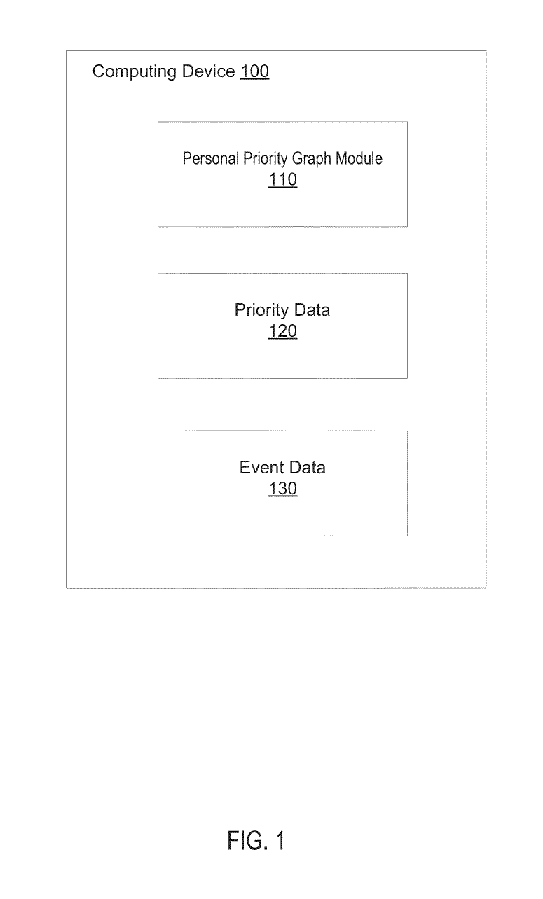

FIG. 1 illustrates an example computing device 100, in accordance with one embodiment of the present disclosure. In some embodiments, computing device 100 communicates to other devices (not shown) or other computing systems (not shown) via a network (not shown). The network may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The computing device 100 may be any type of computing device, for example, a device including a processor, a computer-readable medium, and a memory. In some embodiments, the computing device 100 may be executing a browser application or other application adapted to communicate over Internet related protocols (e.g., TCP/IP and HTTP) and/or display a user interface.

The computing device 100 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single device or on multiple devices. Embodiments of the disclosure may operate as a standalone system.

In one embodiment, the computing device 100 can include a personal priority graph module 110, priority data 120, and event data 130. Priority data 120 can store one or more priorities associated with a user of the computing device 100. Priority data 120 can be personal or professional priorities or goals for the user of the computing device 100. Event data 130 can include information about one or more events associated with the user, information that is a result of the events happening, and other data that is not a result of the events happening, but is relevant to the events.

In one embodiment, the computing device 100 receives a request for a personal priority graph. Personal priority module 110 obtains one or more priorities associated with a user, such as a user of computing device 100. The priority associated with the user can be a personal or professional priority or goal for the user, such as exercise, spending time with friends and family, working, shopping, sleeping, etc. In one embodiment, personal priority module 110 obtains the one or more priorities via a user interface (not shown) of computing device 100. In an alternate embodiment, personal priority module 110 obtains the one or more priorities from priority data 120. Priority data 120 can store the priorities provided by a user or the default priorities. In another alternate embodiment, computing device 100 obtains the one or more priorities from a server or a database. In yet another alternate embodiment, computing device 100 obtains the one or more priorities from a third party service, such as a fitness mobile application, etc.

Personal priority module 110 can obtain event data for one or more events associated with the user. The event data can be obtained from event data 130, or another storage (not shown) storing event data associated with the user. The event data can include information about one or more events, information that is a result of the events happening, and other data that is not a result of the events happening, but is relevant to the events.

Personal priority module 110 obtains experience annotation for the event data reflecting the user's response or experience of an event in the event data, such as an emotional rating for one or more of the events in the event data.

Personal priority module 110 can generate a priority graph unit based on the event data and the experience annotation for the event. The priority graph unit can represent a portion of the user's life (e.g., time, experience, etc.) and the value or priority factor of the event to the user. In one embodiment, personal priority module 110 generates a priority graph unit to represent the event data in relation to the experience annotations. In this embodiment, personal priority module 110 generates the priority graph unit by analyzing the event data and the experience annotation to determine how the events in the event data cause the corresponding experience annotations. For example, the events in the event data are analyzed to determine which events drive more satisfied experiences. In one embodiment, personal priority module 110 generates a priority graph unit to represent the event data and experience annotations in relation to one or more of the user priorities. In this embodiment, personal priority module 110 generates the priority graph unit by evaluating the experience annotations for the events in the event data to determine the events that help the user achieve his or her priorities. For example, for a user priority of being energized, the experience annotations for events are analyzed to determine the events in the event data that cause the user to feel more energized. Personal priority module 110 creates a personal priority graph for the user based on the priority graph unit. The personal priority graph can present a goal associated with one or more priorities of the user, rate the experience of the user and track results of the user. The personal priority graph can include event data over time in relation to the user's priorities, such as the amount of time during a timeframe that the user performed events for the priority in relation to the other events that the user performed during the timeframe.

The personal priority graph for the user can include actionable information to assist the user to satisfy the priority. Personal priority module 110 can create the actionable information by analyzing the priority of the user and historical data for the user in the priority graph unit to discover and recommend areas of personal growth opportunities. Personal priority module 110 can learn from preferences and responses across a network of users and modify analytics to create the actionable information for the user. Personal priority module 110 can perform advanced clustering methods and machine learning to continually improve the actionable information.

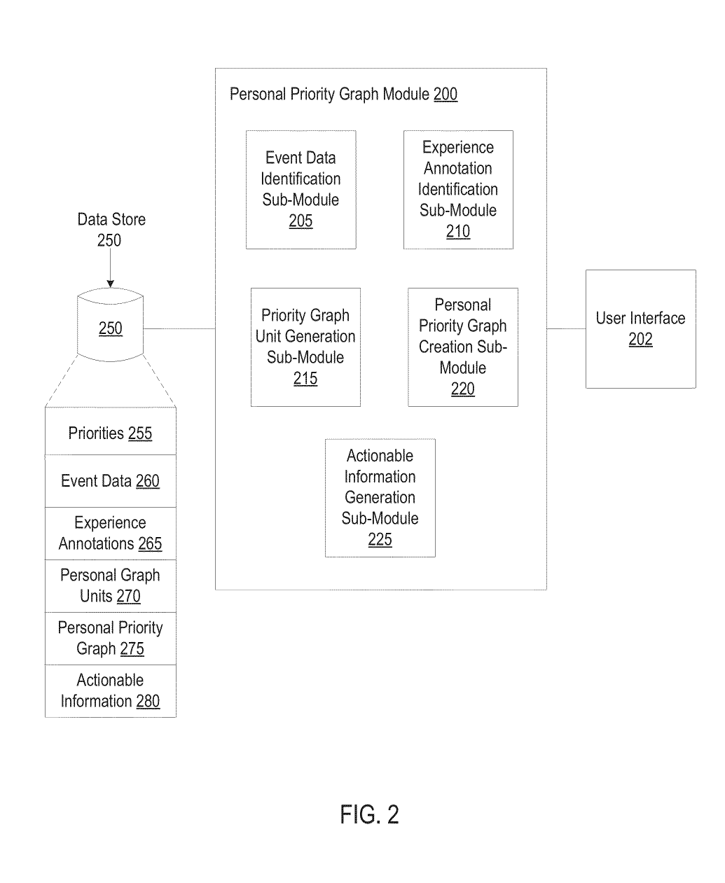

FIG. 2 illustrates a personal priority graph module 200, in accordance with one embodiment of the present disclosure. The personal priority graph module 200 may include event data identification sub-module 205, experience annotation identification sub-module 210, priority graph unit generation sub-module 215, a personal priority graph creation sub-module 220, and an actionable information generation sub-module 225. More or less components may be included in personal priority graph module 200 without loss of generality.

Event data identification sub-module 205 identifies event data related to one or more priorities. In one embodiment, event data identification sub-module 205 identifies the event data for each priority associated with a user. In an alternate embodiment, event data identification sub-module 205 identifies the event data for a single priority associated with the user. In another alternate embodiment, event data identification sub-module 205 identifies event data associated with one or more users. In one embodiment, event data identification sub-module obtains the one or more priorities from a data store, such as priorities 255 in data store 250. In an alternate embodiment, event data identification sub-module 205 obtains the one or more priorities from a user via a user interface, such as user interface 202. The event data can be related to one or more events associated with the user. For each event in the event data, the event data can include a start time and end time for each event, a duration of each event, and a description of each event, as well as information that is a result of the event happening and other data that is not a result of the event happening, but is relevant to the event.

Event data identification sub-module 205 can identify the event data by obtaining events and/or activities associated with the user from various sources (not shown). In one embodiment, event data identification sub-module 205 selects the events and/or activities that relate to the priority as the event data. In an alternate embodiment, event data identification sub-module 205 selects the events associated with the user as the event data. In another alternate embodiment, event data identification sub-module 205 selects the events associated with the user and one or more other individuals as the event data. The various sources used to identify the event data can be default sources or can be customized by the user. The various sources can include calendar information associated with the user, phone information associated with the user, emails associated with the user, text messages associated with the user, contact information associated with the user, and other information available on a computing device of the user, such as a mobile phone used by the user, a computer used by the user, a tablet used by the user, a media center, a personal health device, etc. In some embodiments, the various sources can further include additional sources, such as third party services, software applications running on mobile or other computing devices, etc. Event data identification sub-module 205 can store the event data in a data store, such as event data 260 in data store 250

Experience annotation identification sub-module 210 can identify one or more experience annotations for the event data stored in event data 260. The experience annotation can reflect the user's response or experience of an event in the event data, such as an emotional rating for the event or multiple events. In one embodiment, experience annotation identification sub-module 210 identifies the experience annotation using a user interface, such as user interface 202. In an alternate embodiment, experience annotation identification sub-module 210 identifies the experience annotation from a measuring device, such as a facial recognition device that can determine an experience annotation based on the facial expression(s) of the user, a heart rate monitor, blood pressure monitor, etc. Upon identifying the experience annotation, experience annotation identification sub-module 210 can store the experience annotation in a data store, such as experience annotations 265 in data store 250.

Priority graph unit generation sub-module 215 can generate a priority graph unit for the event based on the event data 260 and the experience annotations 265. The priority graph unit can represent a portion of the user's life (e.g., time, experience, etc.) and the value or priority factor of the event to the user. In one embodiment, priority graph unit generation sub-module 215 generates the priority graph unit by generating a structured record associating the event data for an event with the experience annotation for the event. In this embodiment, priority graph unit generation sub-module 215 analyzes the event data for the event and the experience annotation for the event to determine how the event in the event data caused the corresponding experience annotation or a cause of the experience annotation. In one embodiment, priority graph unit generation sub-module 215 generates the priority graph unit by generating a structured record associating a group of events in the event data with an experience annotation. In this embodiment, priority graph unit generation sub-module 215 indirectly associates the experience annotation with a group of events to determine a cause of the experience annotation and supplement outcome information captured directly in a single event. Priority graph unit generation sub-module 215 can generate the priority graph unit to include an evaluation of the events in the event data that help the user achieve his or her priorities based on the experience annotations for the events. Priority graph unit generation sub-module 215 can store the priority graph unit in a data store, such as priority graph units 270 in data store 250.

Personal priority graph creation sub-module 220 can create a personal priority graph for the user based on the priority graph unit. The personal priority graph can create a personal priority graph to present a goal associated with one or more priorities of the user, rate the experience of the user and track results of the user. Personal priority graph creation sub-module 220 can create the personal priority graph to include event data over time in relation to the experience annotation or the priorities of the user, such as the amount of time during a timeframe that the user performed events for the priority in relation to the other events that the user performed during the timeframe. Personal priority graph generation unit 220 can store the personal priority graph in a data store, such as personal priority graphs 275 in data store 250. Personal priority graph generation sub-module 220 can present the personal priority graph to a user via a user interface, such as user interface 202.

Actionable information generation sub-module 225 can generate actionable information to assist the user to satisfy a priority in the personal priority graph. Actionable information generation sub-module 225 can generate the actionable information by calculating a level of alignment for each priority associated with the user and determining adjustments. In one embodiment, actionable information generation sub-module 225 calculates a level of alignment based on the event data 260 and priorities 255, and can define a ratio of what the user has done to meet the priority based on the event data. In an alternate, actionable information generation sub-module 225 determines actionable information based on event data 260 and the experience annotations 265. Actionable information generation sub-module 225 can generate the actionable information to include suggested changes that a user should make to future events based on past events, provide information to a user of past events to the user such that the user can get to know himself or herself in terms of events and priorities, etc. Actionable information generation sub-module 225 can store the actionable information in a data store, such as actionable information 260 in data store 250. In one embodiment, personal priority graph presentation sub-module 220 includes the actionable information in the personal priority graph presented to the user. In an alternate embodiment, actionable information generation sub-module 225 presents the actionable information 280 to a user in a user interface, such as user interface 202.

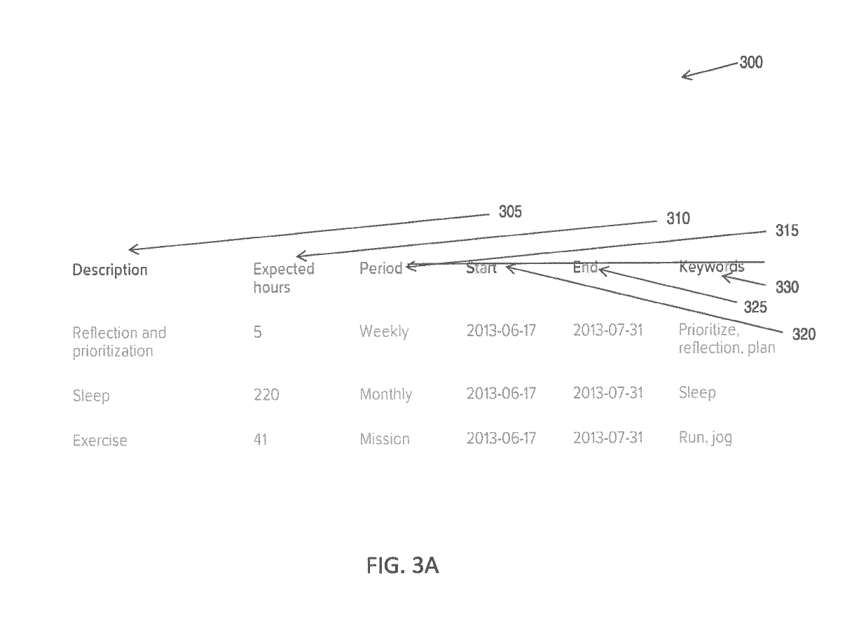

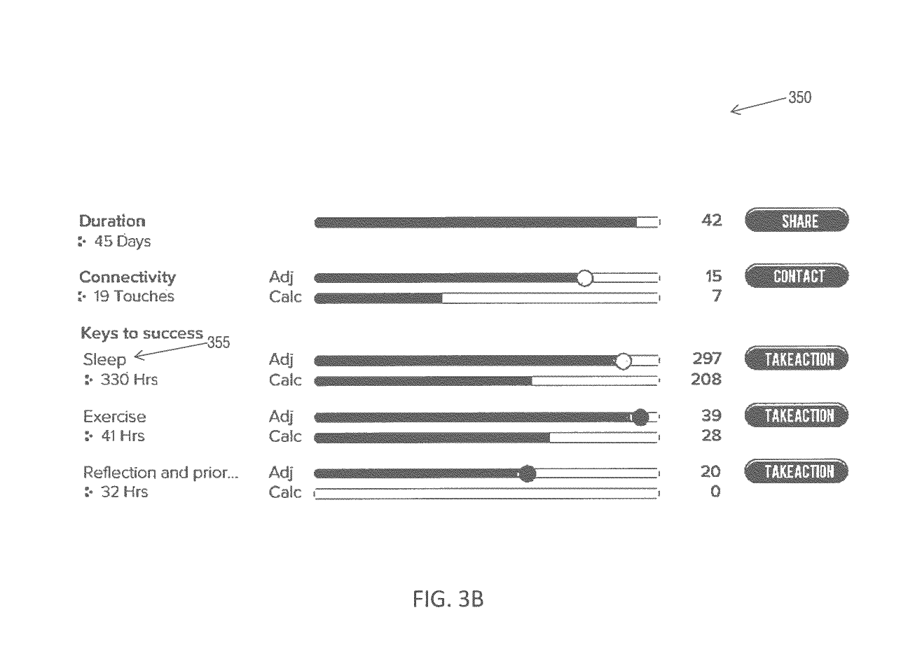

FIG. 3A illustrates an example user interface 300 of a set of priorities associated with a user according to various implementations. The user interface 300 can be created based on a user-defined priority or a default priority. Each priority in user interface 300 can include an identifier 305, such as a description. For example, the identifier 305 includes a reflection and prioritization priority, a sleep priority, and an exercise priority. Each priority in the user interface 300 can include a metric for success 310 to define how the priority is met or considered successful. For example, the metric for success 310 includes 5 hours for the reflection and prioritization priority, 220 hours for the sleep priority, and 41 hours for the exercise priority. Each priority in user interface 300 can include a time frame 315 for the priority to define how long the priority will last. For example, the time frame 315 includes a weekly priority for the reflection and prioritization priority, a monthly period for the sleep priority, and an assessment period for the exercise priority. The time frame 315 can represent a specific timeframe in which the user wants to create or refine a priority graph. The time frame 315 can further include a start time 320 and an end time 325 to further define a start and end time for the time frame. Each priority in user interface 300 can include one or more keywords 330 associated with each priority. For example, keywords 330 include prioritize, reflection, and plan keywords for the reflection and prioritization priority, a sleep keyword for the sleep priority, and run and job keywords for the exercise priority.

FIG. 3B illustrates an example user interface 350 for providing a personal priority graph for a set of priorities, including a visualization of a level of alignment between the events and the priority of a user. The user interface can be created based on a priority graph unit correlating one or more priorities associated with a user and event data associated with the user. The user interface 350 can provide a visualization of a ratio of the event data (both current and historical) and a goal of the priority. For example, user interface 350 illustrates that a user whose goal 355 was three hundred and thirty (330) hours of sleep has completed two hundred ninety-seven (297) hours of sleep.

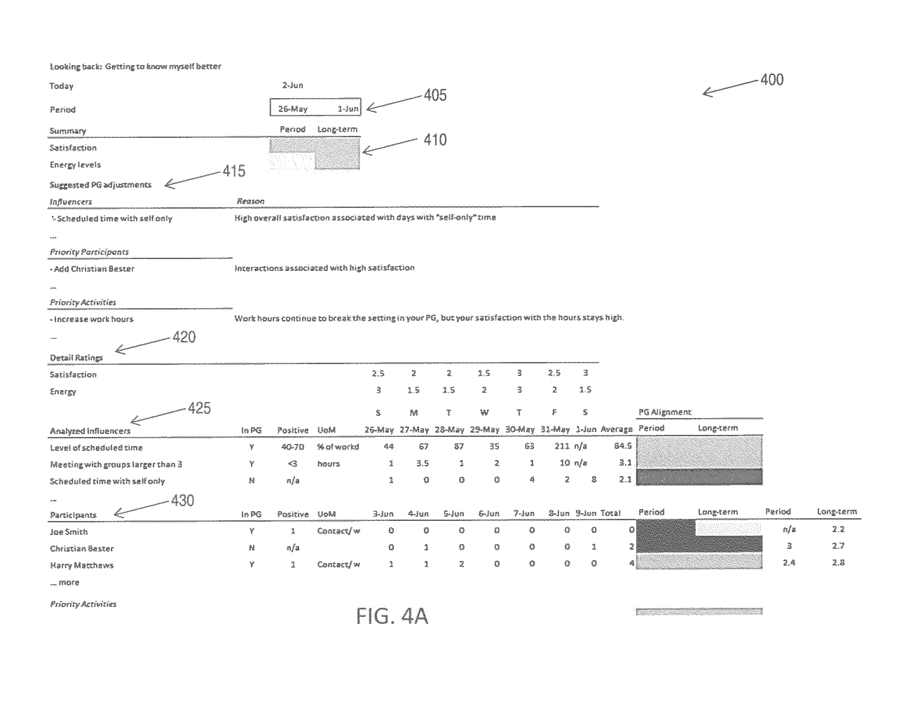

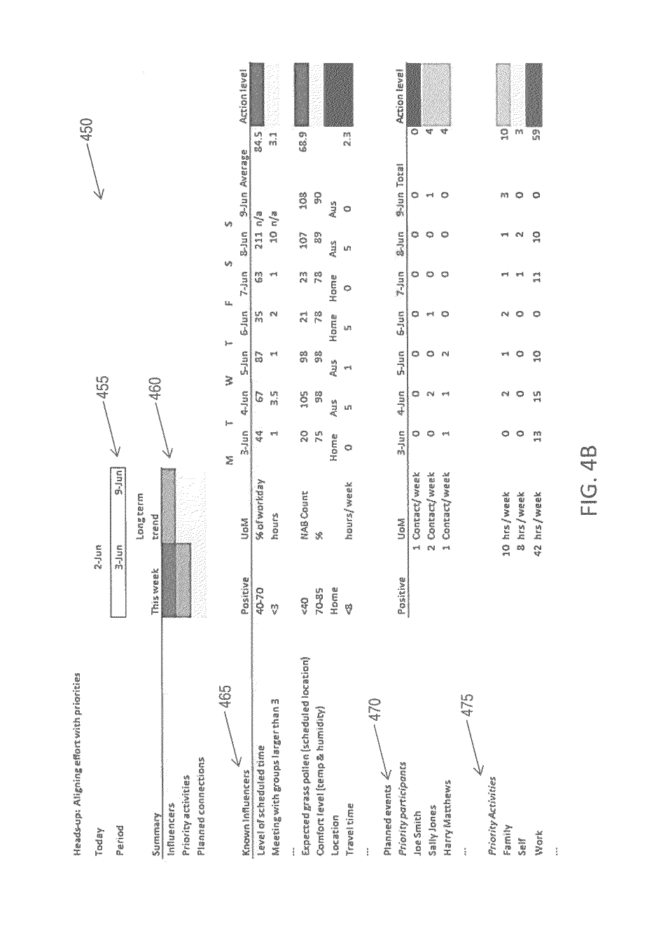

FIG. 4A illustrates an example user interface 400 for providing information to a user based on a priority graph unit. The user interface 400 can include a period of time 405 to which the information applies, a summary 410 of experience annotations on which the information was based, actionable information 415, detail ratings 420, analyzed influencers 425, and participants 430. The summary 410 of experience annotations on which the information was based can include one or more experience annotations provided by the user for the past events. The actionable information 415 can be based on a priority graph unit that includes correlations between past events and experience annotations, as well as correlations between experience annotations and priorities of the user. The actionable information 415 can provide information to the user of factors that contribute to improved experiences for the user. The analyzed influencers 425 can include information from the event data that influenced the correlations and the actionable information 415 in the priority graph unit. The participants 430 can include other people that influenced the correlations and the actionable information 415.

FIG. 4B illustrates an example user interface 450 for providing information to a user based on a priority graph unit. The user interface 450 can include a period of time 455 to which the information applies, a summary 460 of experience annotations on which the information was based, known influencers 465 for the user that influenced the information, planned events 470 that illustrates the effect of certain participants on the events, and priority activities 475 which the user has or should prioritize. The summary 460 of experience annotations, known influencers 465, planned events 470, and the priority activities 475 can be determined based on a priority graph unit that includes correlations between past events and experience annotations, as well as correlations between experience annotations and priorities of the user. Using the summary 460 of experience annotations, known influencers 465, planned events 470, and the priority activities 475, a user can view the user interface 450 and determine how to better align his or her events to meet his or her priorities.

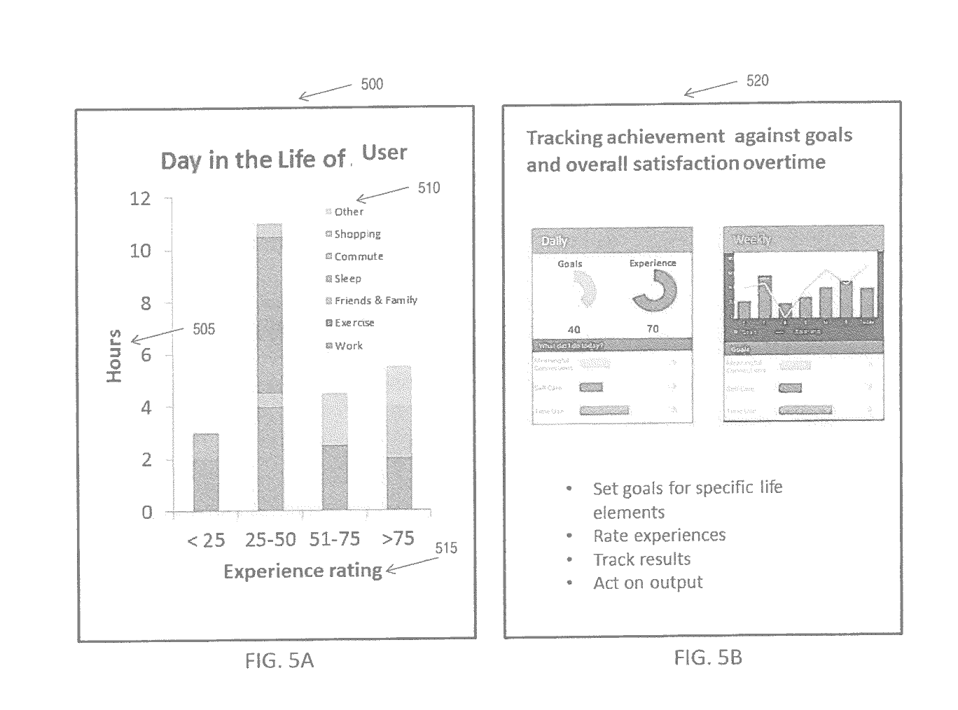

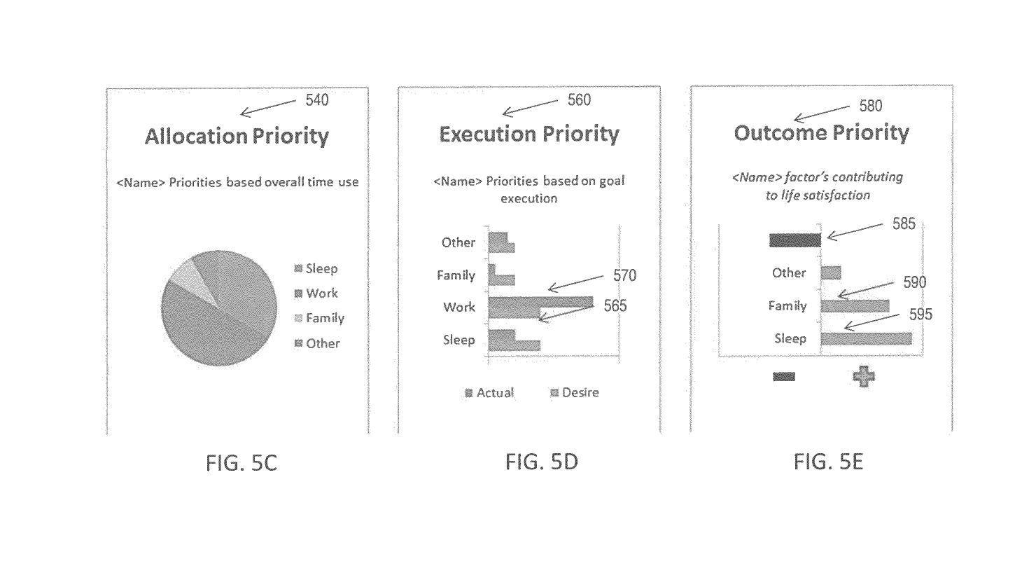

FIG. 5A illustrates an example personal priority graph 500 based on a priority graph unit. The user interface 500 illustrates a resource 505 associated with a user and the events 510 associated with the user that consumed the resources 505. For example, user interface 500 illustrates that the resource 505 was time and how many hours a day the user spent on different events 510. The personal priority graph 500 illustrates the experience annotations 515 for each of the events 510 such that a user can see the experience annotation 515 in view of the events 510 of his or her day. The user interface 500 can be used by the user to take action and modify events to increase his or her experience annotation.

FIG. 5B illustrates an example personal priority graph 520 based on a priority graph unit. The personal priority graph 520 illustrates the user's achievement against goals and overall satisfaction over time.

FIG. 5C illustrates an example personal priority graph 540 based on a priority graph unit. The personal priority graph 540 illustrates an allocation of resources of a user in relation to the events on which the user spent the resources. For example, personal priority graph 540 shows a pie chart illustrating the amount of time (where time is the resource) that a user spent on each event in relation to other events, as well as in relation to the user's overall time.

FIG. 5D illustrates an example personal priority graph 560 based on a priority graph unit. The personal priority graph 560 illustrates a user's actual allocation of resources 570 in view of the user's desired allocation of resources 560. For example, the personal priority graph 560 shows that the user's desired allocation of time to work is desired allocation 565 and that the user's actual allocation of time to work is actual allocation 570. Using personal priority graph 560, the user is able to see how his or her actual allocation of time measures up to his or her desired allocation of time, and the user can adjust his or her actual allocation of time to better meet the desired allocation of time.

FIG. 5E illustrates an example personal priority graph 580 based on a priority graph unit. The personal priority graph 580 illustrates the factors that contribute to an experience annotation or an outcome. For example, the personal priority graph 580 shows that factor 585 (work) negatively contributes to the user's life satisfaction, while factor 590 (family) and factor 595 (sleep) positively contribute to the user's life satisfaction. Using personal priority graph 580, the user is able to see the factors that contribute positively or negatively to the user's experience annotation or outcome.

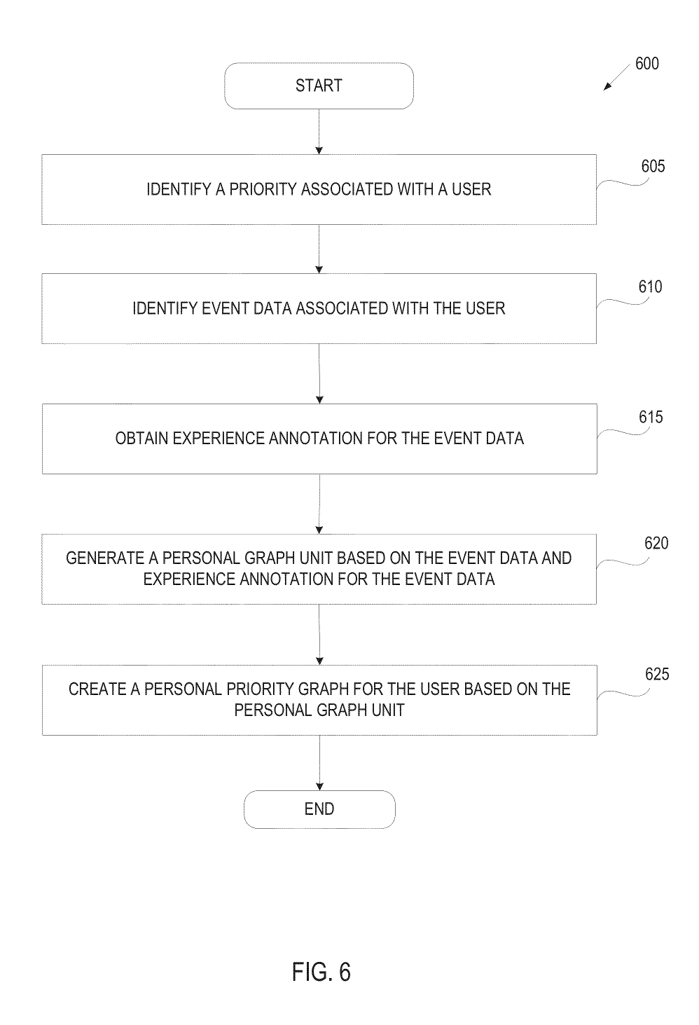

FIG. 6 is a flow diagram of an embodiment of a method 600 for creating a personal priority graph. The method 600 is performed by processing logic that may comprise hardware (circuitry, dedicated logic, etc.), software (such as is run on a general purpose computer system or a dedicated machine), or a combination of both.

At block 605, processing logic identifies a priority associated with a user. In some embodiments, processing logic identifies more than one priority associated with the user. The priority associated with the user can be a personal or professional priority or goal for the user, such as exercise, spending time with friends and family, working, shopping, sleeping, etc. The priority can be defined by a statement provided by the user, and can include an identifier for the priority (e.g., name), a metric for success (e.g., exercise 5 hours a week), and a time frame (e.g., for the next 2 weeks). The priority can further include one or more keywords associated with the priority. In embodiment, the priority further includes the source of the data to use for the priority. For example, the statement for an exercise priority is “exercise for 5 hours a week with a start date of June 20 and an end date of July 5.” If the source of the data to use for the priority is not included, the data for the priority can be sourced from one or more sources linked to the user's profile. An example of a priority associated with a user is described above in reference to FIG. 3A.

In one embodiment, the priority associated with a user is a default priority automatically assigned to the user. The default priority can be a common priority held by most people, such as exercising, spending time with friends and family, sleep, work, etc. The default priority can be customized by the user to create a personalized priority that is specific to the user. In an alternate embodiment, the priority associated with the user is a custom priority created by the user. Processing logic can identify the priority associated with the user by receiving the priority from a user interface, obtaining the priority from storage, etc.

At block 610, processing logic identifies event data associated with a user. The event data can be related to one or more events associated with the user and can include core data and context data. The core data is the basic event data that can be used to build a holistic profile of events in the user's life. For each event in the event data, the core data can include a start time and end time for each event, a duration of each event, and a description of each event. For each event in the event data, the context data can include data that is directly associated with each event and general data. The data that is directly associated with each event can be information that is a result of the event happening, such as the participants in the event, the location of the event, and performance data of the user during the event (e.g., heart rate, distance, speed, etc.). The general data for each event can include data that is not a result of the event happening, but is relevant to the event, such as bio markers, sleep activity, weather information, financial information, world events, extended family, the user's circle of friends, the level that the user was scheduled (e.g., how many other events the user has on the same day, same weekend, same week, etc.), etc.

Processing logic can identify the event data by obtaining events and/or activities associated with the user from various sources and can select the events and/or activities that relate to the priority as the event data. The various sources used to identify the event data can be default sources or can be customized by the user. The various sources can include calendar information associated with the user, phone information associated with the user, emails associated with the user, text messages associated with the user, contact information associated with the user, and other information available on a computing device of the user, such as a mobile phone used by the user, a computer used by the user, a tablet used by the user, a media center, a personal health device, etc. In some embodiments, the various sources can further include additional sources, such as third party services, software applications running on mobile or other computing devices, etc. For example, the third party services can include fitness mobile applications, weight loss coach mobile applications, personal sleep manager mobile applications, personal finance mobile applications, budgeting mobile applications, etc.

In one embodiment, processing logic selects the events and/or activities that relate to the priority as the event data based on the source from which the events and/or activities was collected. For example, the priority is exercise, a fitness mobile application included data for a walk with a coworker on Tuesday, and a personal finance application logged a withdrawal of $100 from the user's bank on Thursday. In this example, processing logic will select the events from the fitness mobile application as the event data because those events are from a source related to exercising (fitness app). In this example, processing logic will not select the withdrawal of $100 as part of the event data because this event was not from a source related to exercising (personal finance app). In an alternate embodiment, processing logic selects the events and/or activities that relate to the priority as the event data based on the title or other metadata of the events and/or activities. For example, the priority is exercise, the user's calendar included an event for a workout on Monday and Wednesday, a fitness mobile application included data for a walk with a coworker on Tuesday, and a personal finance application logged a withdrawal of $100 from the user's bank on Thursday. In this example, processing logic will select the workout events from Monday and Wednesday and the walk with a coworker on Tuesday as the event data because the title and metadata of the events are related to exercising. In this example, processing logic will not select the withdrawal of $100 as part of the event data because the title or metadata of the event was not related to exercising.

In an alternate embodiment, processing logic selects the events and/or activities that are associated with the user or a group of users as the event data from data sources available to the processing logic.

At block 615, processing logic obtains experience annotation for the event data. The experience annotation can be category data, and can include information reflecting the user's response or experience of an event in the event data, such as an emotional rating for the event or for a group of events. For example, the emotional rating is an engagement level of the user for an event in the event data, an energy value of the user for an event in the event data, a satisfaction level of the user for an event in the event data, etc. The experience annotation can be obtained using a user interface, from an annotation provided by the user (e.g., star rating, emoticon, etc.), from a measuring device of the user (e.g., facial recognition device that can determine an experience annotation based on the facial expression(s) of the user, a heart rate monitor, blood pressure monitor, etc.), from another person involved in the event, etc. The experience annotation can include an emotional rating provided by the user that is related to the event data, an emotional rating provided by the user that is related to a bundle of events during a specific time frame, an emotional rating provided by one or more other people that is related to the event data, an emotional rating provided by one or more other people that is related to a bundle of events that occur during a specific time frame, emotional rating obtained from a tool that interprets sensor data, emotional rating calculated based on sensor data, etc. A tool that interprets sensor data can use sensor data, such as facial recognition, tone of voice, body language, behavior patterns, bio marker data, or other non-verbal signs of a user to generate the emotional rating. In some embodiments, processing logic applies machine learning to calibrate or align the obtained emotional rating with the actual experience of the user. Processing logic can train a machine learning system using the event data and experience annotation and apply the machine learning to calibrate or align the emotional rating. Processing logic can train a machine learning system using historical and current event data, trends associated with specific events experienced by the user (e.g., which events cause what experience annotation), and the types of events experienced by the user. In one embodiment, processing logic further trains the machine learning system using prior experience and trends for a group of users (e.g., anonymous group of users, known group of users, etc.). In one such embodiment, processing logic uses non-identifiable attributes to create a group of users most likely to have similar outcomes if exposed to the same events as the individual user for which the personal priority graph is being generated. In another such embodiment, processing logic obtains the group of users from the individual user for which the priority graph is being generated (e.g., using a user interface, etc.).

At block 620, processing logic generates a priority graph unit based on the event data and the experience annotation for the event. The priority graph unit can represent a portion of the user's life (e.g., time, experience, etc.) and the value or priority factor of the event to the user. In one embodiment, the value or priority factor of the user is defined by the user. In an alternate embodiment, the value or priority factor of the user is a default value defined by a service provider. For example, the value or priority factor can be sleep, work, family, etc.

In one embodiment, processing logic generates the priority graph unit by generating a structured record associating the event data for one or more events with an experience annotation. Processing logic can generate the priority graph unit to include an identifier for each event in the event data, the event data, and the experience annotation for the event. Processing logic can analyze the event data for an event and the experience annotation for the event to determine how the event in the event data caused the corresponding experience annotation and include the analysis as part of the priority graph unit. In one embodiment, processing logic creates the priority graph unit by generating a structured record associating a group of events in the event data with an experience annotation. In this embodiment, processing logic indirectly associates the experience annotation with a group of events to supplement outcome information captured directly in a single event. Processing logic can generate the priority graph unit to include an evaluation of the events in the event data that help the user achieve his or her priorities based on the experience annotations for the events. Processing logic can provide the priority graph unit to a machine learning system, including historical and current event data, trends associated with specific events experienced by the user (e.g., which events cause what experience annotation), and the types of events experienced by the user. In one embodiment, the machine learning system is further trained using prior experience and trends for a group of users (e.g., anonymous group of users, known group of users, etc.). Processing logic can obtain information from the machine learning system based on the learning, such as information about what influences the experience annotations of the user, the participants in the events, priorities, etc.

Processing logic can calculate an overall value to include in the priority graph unit based on the event data and the experience annotation using a function of a measure of the user's life determined from the event data and an event rating determined from the experience annotation. In one embodiment, the experience annotation includes ratings from multiple users, and the function assigns weights to the ratings from each of the users. In one embodiment, the experience annotation includes ratings for the event and for a bundle of events (e.g., a day, a week, etc.), and the function assigns weights to the ratings for the event and for the bundle of events. For example, a user Joe works out with Sally on August 1 from 9-10:30 at Location A, Joe provides a rating of 4/5 for the event, Sally provides a rating of 5/5 for the event, and Joe provides a rating of 1/5 for August 1. In this example, the event data for Joe will include workout with Sally, August 1, 9-10:30, Location A and the experience annotation will include 4/5 for Joe for the event, 5/5 for Sally for the event, and 1/5 for Joe's bundle of events. In this example, the weights are 80% for Joe's rating, 0% for another user's rating, and 20% for Joe's bundle ratings. In this example, for Joe, the overall value for the event is calculated as 4/5*80%+5/5*0%+1/5*20%=68%, which is rounded to 7/10.

In an alternate embodiment, processing logic generates the priority graph unit by analyzing the event data and the experience annotation to determine how the events in the event data cause the corresponding experience annotations (e.g., identify trends) and including the results of the analysis in the priority graph unit. Processing logic can perform the analysis by analyzing information about each event in the event data, correlating the information about each event to the experience annotation, and identifying trends for the user based on the correlation (e.g., grouping events with similar characteristics). The information can include the location of the event, other parties involved in the event (e.g., other people), time of the event, outcome of the event, the type of event (e.g., working out, eating, etc.), etc. For example, the event data includes event 1 with person A at the gym with an experience annotation of 8, event 2 with person B at the gym with an experience annotation of 6, and event 3 with person A at lunch with an experience annotation of 9. Processing logic analyzes the information about each event to person (person A and B), the type of event (gym and lunch) in view of the experience annotation. In this example, processing logic generates the priority graph unit to correlate the higher experience annotations at events with person A and/or the higher experience annotations when the type of the event is lunch.

In another alternate embodiment, processing logic generates the priority graph unit by evaluating the experience annotations for the events in the event data to determine the events that help the user achieve his or her priorities. Processing logic can evaluate the experience annotations by analyzing the experience annotations for each event in view of the priorities of the user. For example, a user has a priority for wanting to feel energized by his or her events and provides an experience annotation on Monday of 10 after going to a spinning class, an experience annotation on Tuesday of 5 after going on a run outside, an experience annotation on Wednesday of 3, and an experience annotation on Thursday of 7 after lunch with person A. Processing logic will analyze the experience annotations in view of the priority of wanting to feel energized and create a priority graph unit that represents the user feeling very energized when going to a spinning class and having lunch with person A, less energized when going on a run outside, and very little energy when not working out at all.

At block 625, processing logic creates a personal priority graph for the user based on the priority graph unit. The personal priority graph can include one or more events, one or more experience annotations or outcomes of the events, etc. In one embodiment, processing logic creates the personal priority graph to include an allocation of resources in relation to a total amount of resources in the priority graph unit. In an alternate embodiment, processing logic creates the personal priority graph to include an actual resource allocation in relation to a desired resource allocation in the priority graph unit. In yet another embodiment, processing logic presents the personal priority graph to include the events or factors that contribute to a priority or goal of the user.

Processing logic can generate a personal priority graph based on an allocation of resources in relation to the total amount of resources by using a correlation in the priority graph unit between events and the experience annotations. The resources can include time, money, capital, etc. Processing logic can use the amount of resources used by the user for events for the priority in relation to the resources used by the user for other events not related to the priority. Processing logic can generate the personal priority graph for more than one resource (e.g., time and money). For example, a user shopped, commuted, slept, spent time with friends, exercised and worked in a day, and included experience annotations for each of the events. In this example, the priority graph can be created to indicate how much time (e.g., hours) was spent on each event, as well as the experience annotation associated with each event. An example of a personal priority graph representing an allocation of resources in view of the total available resources is described above in reference to FIG. 5A and FIG. 5C.

Processing logic can create a personal priority graph to include factors or events that contribute to an experience annotation or to a priority based on the priority graph unit. Processing logic can create the personal priority graph to include factors or events that contribute to an experience annotation or to a priority based on the priority graph unit by accessing the information from the personal graph unit. For example, the personal priority graph includes a level of satisfaction from a user's personal interactions with the connections in the user's address book. An example of a personal priority graph representing factors or events that contribute to an experience annotation or to a priority based on the priority graph unit is described above in reference to FIG. 5E.

Processing logic can create a personal priority graph to include an actual resource allocation in relation to a desired resource allocation using an analysis of the experience annotations of events in view of the priorities of the user included in the priority graph unit. For example, processing logic accesses information in the priority graph unit and creates a personal priority graph to include a visualization of a priority of feeling energized in view of the events that caused the user to feel more or less energized. In another example, processing logic creates the personal priority graph to include a level of satisfaction from the personal interactions with the connections in a user's address book. An example of a personal priority graph representing an actual resource allocation in relation to a desired resource allocation is described above in reference to FIG. 5B and FIG. 5D.

Processing logic can generate actionable information as part of the personal priority graph for the user based on a level of alignment for the priority and the priority graph unit to help the user satisfy one or more of the user's priorities. In one embodiment, processing logic calculates a level of alignment for each priority associated with the user by analyzing the event data for data related to each priority, updating priority data for each priority based on the data related to each priority, and determining the level of alignment as a ratio of the updated priority data and a goal of the priority. In an alternate embodiment, processing logic calculates logic calculates a level of alignment for a single priority associated with the user by analyzing the event data for data related to the priority, and updating priority data for the priority based on the data related to the priority. For example, a user defines a priority for exercising 5 hours a week from June 20-July 2 (2 weeks) and records a workout on July 1 of 1.5 hours, and the current amount of time that the user had previously worked out (from June 20-July 1) was 3 hours. In this example, processing logic will receive the event data of a workout on July 1 of 1 hour, analyze the event data to determine that the 1 hour is related to the priority of exercising, and update the amount of time that the user has worked out to 3+1=4 hours. In this example, processing logic will determine the level of alignment for the priority of exercising as 4 hours out of the goal of 10 hours (equal to the priority of exercising 5 hours a week for 2 weeks).

Processing logic can determine actionable information for the user based on the level of alignment and insight into events and context that have a significant impact on the experience annotation of the user stored in the priority graph unit. The actionable information can suggest changes that a user should make to future events based on past events, provide information to a user of past events to the user such that the user can get to know him or herself in terms of events and priorities, etc. A user can use the actionable information to help the user shape his or her longer-term priorities to align more closely with priorities that bring out the best in the user because those priorities were given a higher experience annotation by the user. Processing logic can determine the actionable information based on the level of alignment for a priority and analyses stored in the priority graph unit (e.g., trends for the user based on a correlation between events and experience annotations, events that help the user achieve priorities, etc.). For example, if a user has a level of alignment for an exercise priority that is 4 hours out of the goal of 10, and the priority graph unit includes a correlation of the user having the highest level of exercise when exercising with friend A, processing logic accesses the correlation in the priority graph unit and includes a suggestion as the actionable information that the user ask friend A to exercise for an hour a day for the next 6 days to meet the exercise priority.

Processing logic can present the personal priority graph in a visual format, such as a GUI, a text message, an email, a website, a physical format (e.g., paper report), etc. In one embodiment, processing logic visually displays a level of alignment associated with the personal priority graph in a first display and actionable information associated with the personal priority graph in a second display. In an alternate embodiment, processing logic visually displays the level of alignment and the actionable information in the same display. In another alternate embodiment, processing logic visually displays the level of alignment and actionable information in a different display.

If the personal priority graph includes an actual resource allocation in relation to a desired resource allocation, processing logic can visually display the level of alignment by creating a visual indication of the ratio associated with the priority. Using the previous example for a level of alignment for the priority of exercising of 4 hours out of the goal of 10 hours, processing logic will display the ratio 4/10 or a visual indication of the ratio.

In some embodiments, processing logic can customize the information included in the personal priority graph using an input provided from the user. The user can provide input that the personal priority graph can include a result or outcome of an allocation of resources, an amount of resources allocated to a priority of the user, one or more priorities of the user, etc.

Processing logic can visually display the personal priority graph based on user defined priorities or system generated suggested priorities. Processing logic can visually display the personal priority graph based on user defined priorities in the form of a progress rating against the goal for the priority. For example, if a user is 90% of the way to a priority or goal, the personal priority graph will visually indicate 90% of goal. In another example, if a user has completed a priority or goal, such as exercising 10 hours in a week, the personal priority graph will visually indicate that the goal is complete. Processing logic can visually display the personal priority graph based on system generated suggested priorities based on a user-selected an experience attribute or set of attributes (e.g., excitement, satisfaction, engagement, etc.) to assess. Based on the user-selected attribute or set of attributes, processing logic will provide a relative ranking of elements contributing to the selected attribute or set of attributes.

In an optional embodiment, processing logic shares the actionable information based on privacy and communication preferences associated with the user. The privacy and communication preferences can include when a message including the actionable information is sent, to who the actionable information is sent, the amount of the actionable information that is sent, etc. The actionable information can be sent to no one (e.g., no sharing), to a small trusted group (e.g., accountability group), to one or more 3^{rd} parties, to the public, etc. The amount of actionable information that is sent can include a combination of direct sharing of the actionable information, aggregated markers related to objectives and subjective data elements, and overall trend information. The amount of actionable information that is sent can depend on who the actionable information is being sent to. For example, more actionable information is sent to an accountability group, such as all actionable information, and less actionable information is sent to the public, such as only the overall trend information for the user.

In an optional embodiment, processing logic selects and provides a portion of the actionable information and/or the personal priority graph to one or more personal groups associated with the user. The one or more personal groups associated with the user can include an accountability group that the user has selected to be a part of. By selecting to be part of the group, the user agrees to share a minimum level of information and the group supports the user to meet one or more priorities or goals. Processing logic can select a portion of the actionable information and/or the personal priority graph to provide to the personal group based on a preference of the user.

In an optional embodiment, processing logic selects and provides a portion of the actionable information and/or the personal priority graph to one or more 3^{rd} party services associated with the user. The one or more 3^{rd} party services can include service providers that the user is associated with, such as products, services, etc. The 3^{rd} party services can allow the user to receive customized products and services based on the information provided to the 3^{rd} party services. For example, a user who enjoys working out with someone but is struggling to find a rhythm when travelling receives information on trainers and/or training classes in a new or temporary location that the user is travelling to. In another example, a user who is going through a life change, such as an engagement, marriage, new baby, job change, layoff, death of a close companion, etc., receives information about life coaches. Processing logic can select a portion of the actionable information and/or the personal priority graph to provide to the 3^{rd} party service based on a preference of the user. The preference of the user can include the type of information that is shared and the frequency of sharing the information with the 3^{rd} party services.

In an optional embodiment, processing logic provides the user with updates on progress against goals associated with priorities and prompts the user to take action based on the goals. Processing logic can provide the updates based on personal settings. In one embodiment, processing logic can further provide the updates based on a status of the user and real-time information associated with the user (e.g., captured on a mobile device). The personal settings can select the update to be provided on a predetermined basis (e.g., once a day), when a predetermined threshold is reached (e.g., 70% of the goal), based on the location of the user, etc. For example, if a user has completed 7/10 exercise hours for the week, processing logic can provide the user with a prompt to go to the gym to complete the 3 hours left in the goal. In another example, if the global positioning system (GPS) of the user's mobile device indicates that the user is within a predefined distance (e.g., 0.5 miles) of a friend that he or she has not seen in a predetermined amount of time (e.g., a week) and the calendar information of the user and the friend indicate that both are free, processing logic can provide a suggestion to the user to contact the friend to go to coffee.

In an optional embodiment, processing logic can determine if the user takes action based on the prompt to take action. Upon determining that the user takes action, processing logic can obtain information associated with the action and update a priority graph unit and the user's personal priority graph based on the action.

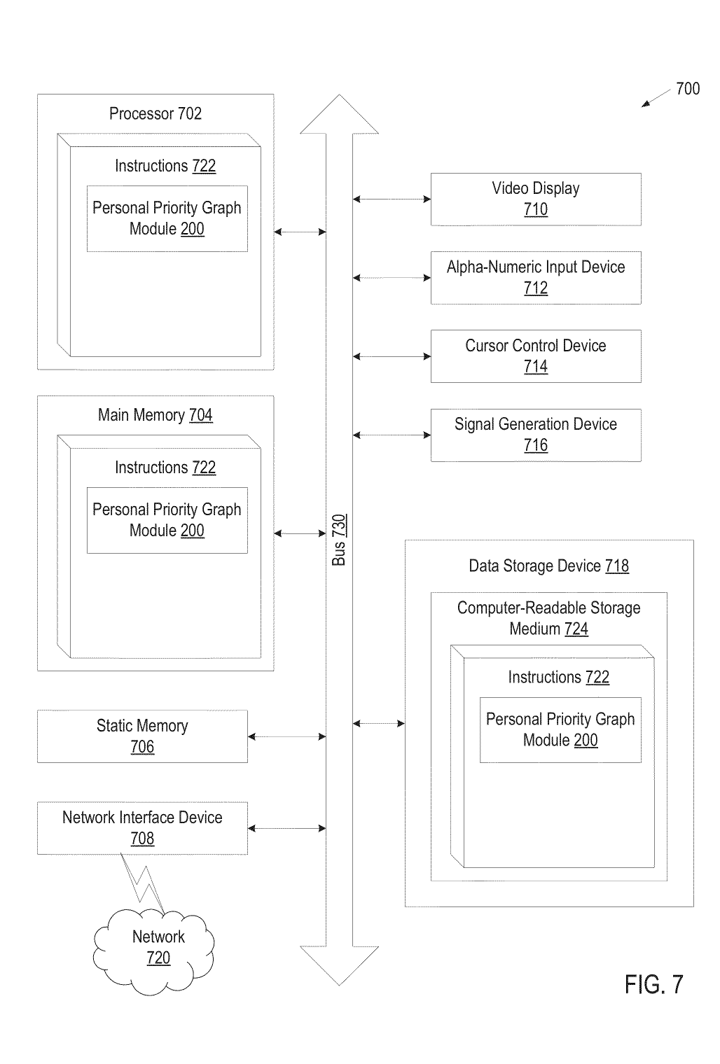

FIG. 7 illustrates a diagram of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 718, which communicate with each other via a bus 730.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute instructions 722 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable storage medium 724 on which is stored one or more sets of instructions 722 (e.g., software) embodying any one or more of the methodologies or functions described herein. The instructions 722 may also reside, completely or at least partially, within the main memory 704 and/or within the processor 702 during execution thereof by the computer system 700, the main memory 704 and the processor 702 also constituting computer-readable storage media. The instructions 722 may further be transmitted or received over a network 720 via the network interface device 708.

In one embodiment, the instructions 722 include instructions for a personal priority graph module (e.g., personal priority graph module 200 of FIG. 2) and/or a software library containing methods that call a personal priority graph module. While the computer-readable storage medium 724 (machine-readable storage medium) is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that causes the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “presenting”, “updating”, “determining”, “calculating,” “providing,” “receiving,” “selecting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be constructed for the intended purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
identifying a priority associated with a user and event data associated with the user;
obtaining an experience annotation for an event, wherein the experience annotation comprises an emotional measure of the event;
generating, by a processing device, a priority graph unit based on the event data associated with the user and the experience annotation for the event; and
creating a personal priority graph for the user based on the priority graph unit.

2. The method of claim 1, wherein generating a priority graph unit based on the event data associated with the user and experience annotation for the event comprises:
associating the event with the experience annotation;
determining a first cause for the experience annotation based on the event;
associating a group of events in the event data with the experience annotation; and
determining a second cause for the experience annotation based on the group of events.

3. The method of claim 1, wherein the experience annotation includes a plurality of ratings, wherein one of the plurality of ratings is from the user and another one of the plurality of ratings is from another user, and wherein the priority graph unit is generated as a weighted function of the plurality of ratings.

4. The method of claim 1, wherein generating the priority graph unit based on the event data associated with the user and experience annotation for the event comprises:
analyzing a plurality of events in the event data;
correlating the plurality of events in the event data to the experience annotation; and
identifying a trend for the user based on the correlation.

5. The method of claim 1, wherein generating the priority graph unit for the event based on the event data associated with the priority and the experience annotation for the event comprises:
evaluating the experience annotation for the event; and
determining whether the event assisted the user to achieve the priority associated with the user.

6. The method of claim 1, wherein the event data associated with the priority comprises a time frame for an event, data that is a result of the event happening, and data that is not a result of the event happening and is relevant to the event.

7. The method of claim 1, wherein the personal priority graph comprises the event data in relation to an allocation of resources associated with the user.

8. The method of claim 1, wherein creating the personal priority graph comprises:
calculating a level of alignment for the priority associated with the user;
determining actionable information for the user based on the priority graph unit and the level of alignment; and
visually displaying, in a user interface, the level of alignment and the actionable information to the user to help the user achieve the priority.

9. The method of claim 1, wherein the personal priority graph comprises an allocation of a resource of the user in relation to a priority of the user.

10. The method of claim 1, further comprising:
selecting a portion of the priority graph unit based on a preference associated with the user; and
sharing the portion of the priority graph unit to assist the user to be accountable.

11. A non-transitory computer readable storage medium having instructions that, when executed by a processing device, cause the processing device to perform operations comprising:
identifying a priority associated with a user and event data associated with the user;
obtaining an experience annotation for an event, wherein the experience annotation comprises an emotional measure of the event;
generating a priority graph unit based on the event data associated with the priority and the experience annotation for the event; and
creating a personal priority graph for the user based on the priority graph unit.

12. The non-transitory computer readable storage medium of claim 11, wherein to generate a priority graph unit based on the event data associated with the user and the experience annotation for the event, the instructions, when executed by the processing device, cause the processing device to perform operations comprising:
associating the event with the experience annotation;
determining a first cause for the experience annotation based on the event;
associating a group of events in the event data with the experience annotation; and
determining a second cause for the experience annotation based on the group of events.

13. The non-transitory computer readable storage medium of claim 11, wherein the experience annotation includes a plurality of ratings, wherein one of the plurality of ratings is from the user and another one of the plurality of ratings is from another user, and wherein the priority graph unit is generated as a weighted function of the plurality of ratings.

14. The non-transitory computer readable storage medium of claim 11, wherein to generate the priority graph unit based on the event data associated with the user and experience annotation for the event, the instructions, when executed by the processing device, cause the processing device to perform operations comprising:
analyzing a plurality of events in the event data;
correlating the plurality of events in the event data to the experience annotation; and
identifying a trend for the user based on the correlation.

15. The non-transitory computer readable storage medium of claim 11, wherein creating the personal priority graph, the instructions, when executed by the processing device, cause the processing device to perform operations comprising:
calculating a level of alignment for the priority associated with the user;
determining actionable information for the user based on the priority graph unit and the level of alignment; and
visually displaying, in a user interface, the level of alignment and the actionable information to the user to help the user achieve the priority.

16. The non-transitory computer readable storage medium of claim 11, wherein the instructions, when executed by the processing device, cause the processing device to perform operations further comprising:
selecting a portion of the priority graph unit based on a preference associated with the user; and
sharing the portion of the priority graph unit to assist the user to be accountable.

17. A computing device comprising:
a memory; and
a processing device coupled to the memory, wherein the processing device is to:
identify a priority associated with a user and event data associated with the user;
obtain an experience annotation for an event, wherein the experience annotation comprises an emotional measure of the event;
generate a priority graph unit based on the event data associated with the user and the experience annotation for the event; and
create a personal priority graph for the user based on the priority graph unit.

18. The computing device of claim 17, wherein to generate a priority graph unit based on the event data associated with the user and experience annotation for the event, the processing device is further to:
associate the event with the experience annotation;
determine a first cause for the experience annotation based on the event;
associate a group of events in the event data with the experience annotation; and
determine a second cause for the experience annotation based on the group of events.

19. The computing device of claim 17, wherein to generate the priority graph unit based on the event data associated with the priority and experience annotation for the event, the processing device is to:
analyze a plurality of events in the event data;
correlate the plurality of events in the event data to the experience annotation; and
identify a trend for the user based on the correlation.

20. The computing device of claim 17, wherein to create the priority graph unit based on the event data associated with the priority and experience annotation for the event, the processing device is to:
evaluate the experience annotation for the event; and
determine whether the event assisted the user to achieve the priority associated with the user.
